(19) United States
(12) Patent Application Publication
(10) Pub. No.: US 2013/0086515 A1
(43) Pub. Date: Apr. 4, 2013

(54) User Inferface

(71) Applicant: Lene Leth Rasmussen, Copenhagen V. (DK)

(72) Inventor: Lene Leth Rasmussen, Copenhagen V. (DK)

(73) Assignee: NOKIA CORPORATION, Espoo (FI)

(21) Appl. No.: 13/250,633

(22) Filed: Sep. 30, 2011

(51) Int. Cl. G06F 3/048

(52) U.S. Cl. 715/792

(57) ABSTRACT

An apparatus comprising: a first display area; a second display area; and an interface separating the first display area from the second display area; and a display controller configured to move a displayed user interface element to track in real-time a user input point controlled by a user in a first display area and to move the displayed user interface element from the first display area to a second display area automatically when a criteria is satisfied.

### TECHNOLOGICAL FIELD

Embodiments of the present invention relate to a user interface comprising a first display area and a second display area.

### BACKGROUND

A user interface is a man-machine interface by which an apparatus communicates to a user and/or by which a user communicates to the apparatus.

A user interface may comprise one or more displays with distinct display areas.

### BRIEF SUMMARY

It would be desirable to use two distinct display areas separated by an interface, such as for example a gap, as a single display area. However, the presence of the gap can make this problematic as it creates an interrupt in the single display area.

According to various, but not necessarily all, embodiments of the invention there is provided an apparatus comprising: a first display area; a second display area; and an interface separating the first display area from the second display area; and a display controller configured to move a displayed user interface element to track in real-time a user input point controlled by a user in a first display area and to move the displayed user interface element from the first display area to a second display area automatically when a criteria is satisfied.

According to various, but not necessarily all, embodiments of the invention there is provided a method comprising: moving a displayed user interface element to track in real-time a user input point controlled by a user in a first display area; and moving the displayed user interface element from the first display area to a second display area automatically when a criteria is satisfied.

According to various, but not necessarily all, embodiments of the invention there is provided an apparatus comprising: at least one processor; and at least one memory including computer program code the at least one memory and the computer program code configured to, with the at least one processor, cause the apparatus at least to perform: moving a displayed user interface element to track in real-time a user input point controlled by a user in a first display area; moving the displayed user interface element from the first display area to a second display area automatically when a criteria is satisfied.

According to various, but not necessarily all, embodiments of the invention there is provided an apparatus comprising: means for moving a displayed user interface element to track in real-time a user input point controlled by a user in a first display area; means for moving the displayed user interface element from the first display area to a second display area automatically when a criteria is satisfied.

### BRIEF DESCRIPTION

For a better understanding of various examples of embodiments of the present invention reference will now be made by way of example only to the accompanying drawings in which:

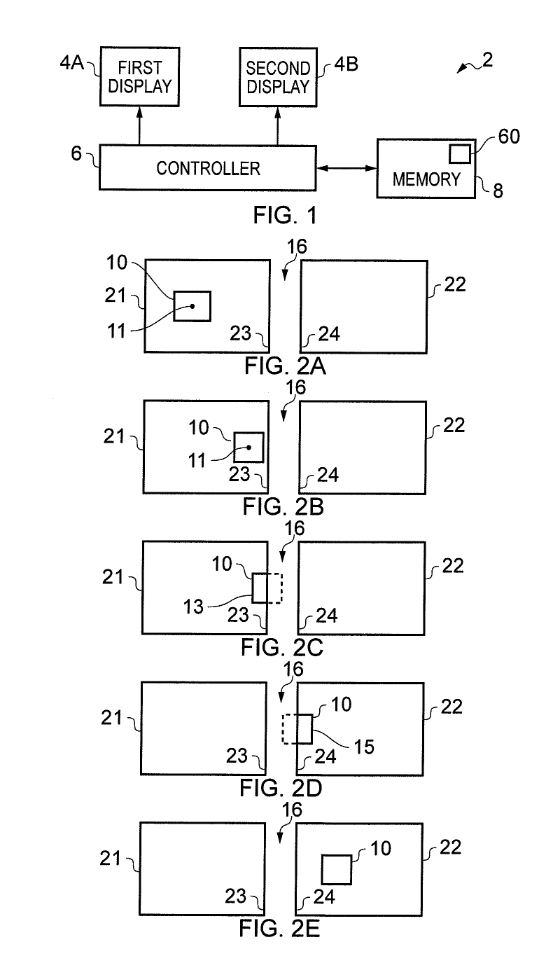

FIG. 1 illustrates an example of an apparatus;

FIG. 2A-2E illustrate a user interface element moving from a first display area to a second display area across an interface separating the first display area and the second display area;

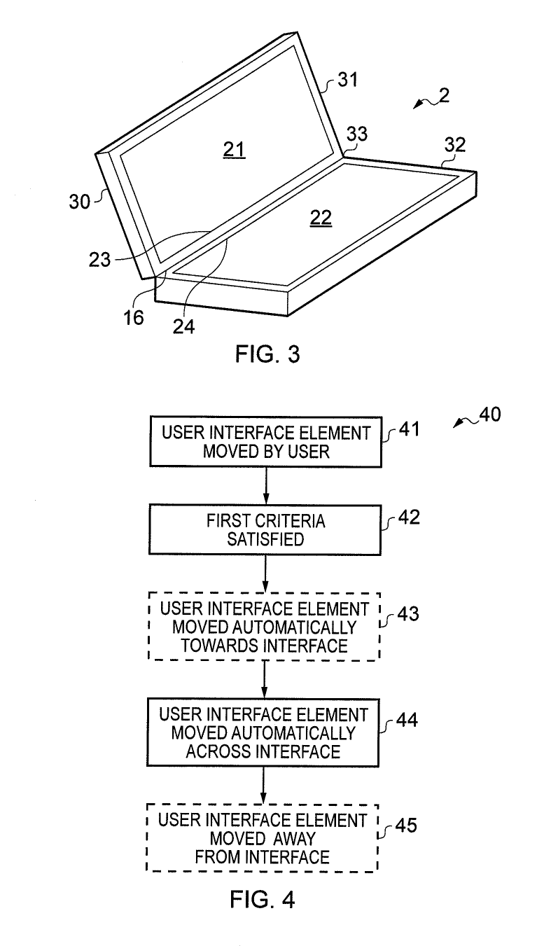

FIG. 3 illustrates in perspective view an example of a dual display apparatus;

FIG. 4 schematically illustrates a method for controlling movement of the user interface element from a first display area to a second display area across an interface separating the first display area and the second display area;

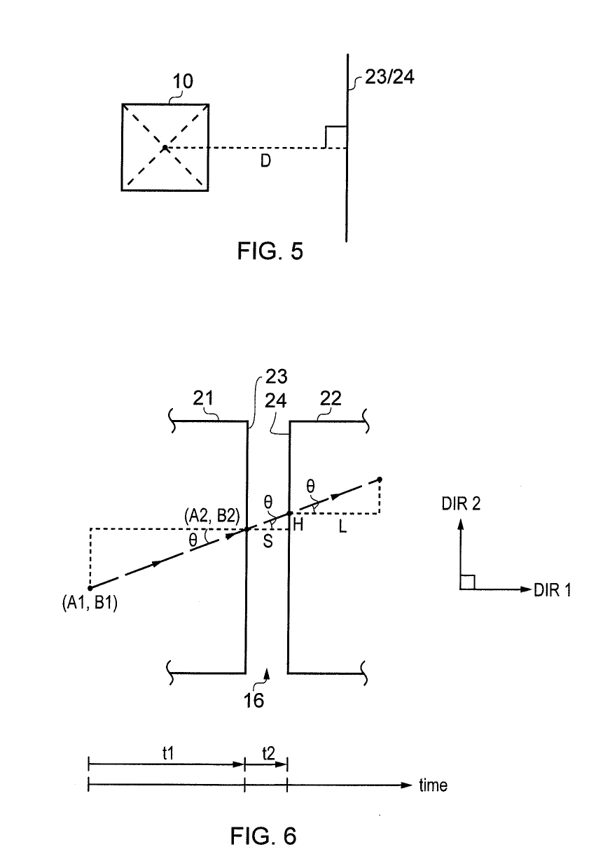

FIG. 5 schematically illustrates examples of a criteria concerning a distance of the user interface element from the interface;

FIG. 6 schematically illustrates movement of the user interface element from a first display area to a second display area across an interface

### DETAILED DESCRIPTION

The Figures illustrate an apparatus 2 comprising: a first display area 21; a second display area 22; and an interface separating the first display area 21 from the second display area 22; and a display controller 6 configured to move a displayed user interface element 10 to track in real-time a user input point 11 controlled by a user in a first display area 21 and to move the displayed user interface element 10 from the first display area 21 to a second display area 22 automatically when a criteria is satisfied.

Although the term criteria is normally used to indicate more than one criterion, in this document the term ‘criteria’ should be understood to indicate one or more criterion.

FIG. 1 illustrates an example of an apparatus 2 comprising: a first display 4A defining a first display area 21; a second display 4B defining a second display area 22; and a display controller 6 configured to move a displayed user interface element 10 from the first display area 21 to the second display area 22 automatically when a criteria is satisfied.

The apparatus 2 may, for example, be an electronic apparatus such as a personal digital assistant, personal media player, mobile cellular telephone, personal computer, a point of sale terminal etc. In some embodiments the apparatus 2 may be a hand-portable apparatus, that is, an apparatus that is sized to be carried in the palm of a hand or in a jacket pocket.

The display controller 6 is configured to move a displayed user interface element 10 to track in real-time a user input point 11 controlled by a user in a first display area 21 and to move the displayed user interface element 10 from the first display area 21 to a second display area 22 automatically when a criteria is satisfied.

The display controller 6 may also be configured to move a displayed user interface element 10 to track in real-time a user input point 11 controlled by a user in the second display area 22 and to move the displayed user interface element 10 from the second display area 22 to the first display area 21 automatically when a criteria is satisfied.

FIGS. 2A to 2E schematically illustrate a first display area 21; an adjacent second display area 22; and an interface 16 separating the first display area 21 from the second display area 22. A user interface element 10 is movable across the interface 16 from the first display area 21 to the second display area 22 and is movable across the interface from the second display area 22 to the first display area 21.

The user interface element 10 is movable in the first display area 21 and the second display area 22 in response to user input. The user interface element 10 is moved automatically across the interface 16 when the criteria is satisfied.

In this example, the first display area 21 and the second display area 22 are ‘landscape’ with a width dimension exceeding a height dimension. In other embodiments the first display area 21 and the second display area 22 may be portrait with a width dimension less than a height dimension.

In this example, the first display area 21 and the second display area 22 are the same size. In other embodiments they may be of different size.

The first display area 21 has an edge 23 nearest the second display area 22. The second display area 22 has an edge 24 nearest the first display area 21. The edges 23 and 24 are in this example, but not necessarily all examples, rectilinear and parallel. The distance separating the edges 23, 24 may in some embodiments be less than 5 mm.

In this example, the edges 23, 24 are height-wise edges with the first display area 21 and the second display area side-by-side. However in other embodiments (e.g. FIG. 3), the edges 23, 24 may be width-wise edges with the first display area 21 and the second display area 22 above-below each other.

There is an interface 16 between the edge 23 of the first display area 21 and the edge 24 of the second display area 22. The interface 16 separates the first display area 21 from the second display area 22 and does not operate as a display. The interface 16 in the illustrated example forms a gap where a user interface element 10 cannot be displayed.

In FIG. 2A, the criteria is not satisfied. FIG. 2A illustrates movement of a user input point 11 controlled by a user in a first display area 21. The display controller 6 is configured to move the displayed user interface element 10 to track in real-time the moving user input point 11. The user input point 11 may be moved using a user input device such as, for example, a mouse, touch screen, joystick etc. Moving the user input point 11 drags the user interface element 10 along.

In FIG. 2B, the criteria is satisfied. FIG. 2B illustrates the start of automatic movement of the displayed user interface element 10 from the first display area 21 to a second display area 22.

FIG. 2C illustrates an intermediate stage in the automatic movement of the displayed user interface element 10 from the first display area 21 to a second display area 22. In this Figure, only a trailing portion 13 of the user interface element 10 remains visible in the first display area 21. The leading portion of the user interface element 10 is not displayed. The illusion is that it is ‘under’ the interface 16 as illustrated using dotted lines.

FIG. 2D illustrates another intermediate stage in the automatic movement of the displayed user interface element 10 from the first display area 21 to a second display area 22. In this Figure, only a leading portion 15 of the user interface element 10 is visible in the second display area 22. The trailing portion of the user interface element 10 is not displayed. The illusion is that it is ‘under’ the interface 16 as illustrated using dotted lines.

FIG. 2E illustrates a final stage in the automatic movement of the displayed user interface element 10 from the first display area 21 to a second display area 22. In this Figure, a whole of the user interface element 10 is visible in the second display area 22.

FIG. 3 illustrates in perspective view an example of a dual display apparatus 2. In this example the first display area 21 is rotatable relative to the second display area 22 about an axis in the gap 16.

The apparatus 2 comprises a housing 30 that has a first housing part 31 connected to a second housing part 32 via a hinge 33. The first housing part 31 supports the first display 4A defining the first display area 21. The second housing part 32 supports the second display 4B defining the second display area 22.

The straight edge 23 of the first display area 21 nearest the gap 16 is parallel to the straight edge 24 of the second display area 22 nearest the gap 16. Separation between the edges 23, 24 is constant and may be less than 5 mm.

The gap 16 is occupied in this example by a portion of the first housing part 31, the hinge 33 and a portion of the second housing part 32.

The first display 4A and/or the second display 4B may be a touch sensitive display. A touch sensitive display is capable of providing output to a user and also capable of simultaneously receiving touch or proximity input from a user while it is displaying.

A user interface element 10 may be any item that is displayable on a display used as a user interface. It may, for example, be an icon, widget or similar. It may, for example, be an output from an application such as an application window.

The user interface element 10 may be static or dynamic. Static means that it does not change appearance over time. Dynamic means that it changes appearance (shape or color etc) over time.

FIG. 4 schematically illustrates a method 40 for controlling movement of the user interface element 10 from a first display area 21 to a second display area 22 across an interface 16 separating the first display area 21 and the second display area 22.

At block 41, a displayed user interface element 10 is moved to track in real-time a user input point 11 controlled by a user in a first display area 21.

At block 42 it is determined that a criteria is satisfied. The criteria may be dependent upon a distance of the user interface element 10 from the interface 16.

At optional block 43, if present, the displayed user interface element 10 is moved automatically in the first display area 21 towards the interface 16.

At block 44 the displayed user interface element 10 is moved automatically from the first display area 21 to the second display area 22 across the interface 16.

At optional block 45, if present, the displayed user interface element 10 is moved automatically or manually in the second display area 22 away from the interface 16.

In one embodiment, block 43 is absent and the display controller 6 is configured to move manually a leading portion 15 of the displayed user interface element 10 to the edge 23 of the first display area 21 immediately prior to the automatic movement of the displayed user interface element 10 from the first display area 21 to the second display area 22 at block 44. In this example, only when the leading portion 15 of the displayed user interface element 10 reaches the edge 23 of the first display area 21 is the criteria satisfied at block 42. Manual movement is in response to movement of a user input point 11 in the first display area 21 controlled by a user.

In another embodiment, block 43 is present and the display controller 6 is configured to automatically move a leading portion 15 of the displayed user interface element 10, when the criteria is satisfied, to the edge 23 of the first display area 21 immediately prior to the automatic movement of the displayed user interface element 10 from the first display area 21 to the second display area 22 at block 44.

In some embodiments, block 45 is present and the displayed user interface element 10 may be moved manually in the second display area 22 away from the interface 16. The display controller 6 may be configured to move manually the displayed user interface element 10 from the edge 24 of the second display area 22 immediately following automatic movement of the displayed user interface element 10 across the interface 16. Manual movement is in response to movement of a user input point in the second display area 22 controlled by a user.

In some embodiments, block 45 is present and the displayed user interface element 10 may be moved automatically in the second display area 22 away from the interface 16. The display controller 6 may be configured to move the displayed user interface element 10 automatically from the edge 24 of the second display area 22 immediately following automatic movement of the displayed user interface element 10 across the interface 16 from the first display area 21.

FIG. 5 schematically illustrates examples of a criteria dependent upon a distance of the user interface element 10 from the interface 16. The Figure illustrates a user interface 10 at a distance D from the edge 23/24 of the display area 21/22 in which the user interface element 10 is displayed. The distance D is the shortest distance between the user interface element 10 and the interface 16.

The criteria concerning a distance of the user interface element 10 from the interface 16 may, for example, be satisfied when:
a) a proximity criteria is satisfied and/or
b) a velocity criteria is satisfied and/or
c) a momentum criteria is satisfied.

An example of a proximity criteria is that the shortest distance D between the user interface element 10 and the interface 16 is less than a distance threshold value T_{D}. The proximity criteria is then D<T_{d}.

An example of a velocity criteria is that the change in the shortest distance D between the user interface element 10 and the interface 16 over time exceeds a speed threshold value T_{D}′. The velocity criteria is then dD/dt>T_{d}′.

An example of a momentum criteria is that the change in the shortest distance D between the user interface element 10 and the interface 16 over time exceeds an inertia dependent threshold value T_{D}″/M where M is a measure of inertia. The momentum criteria is then dD/dt>T_{d}″/M. The inertia M may be dependent upon a characteristic of the user interface element 10 such as the type of user interface element or the size (maximum dimension or area, for example) of the user interface element 10.

FIG. 6 schematically illustrates movement of the user interface element 10 from a first display area 21 to a second display area 22 across an interface 16.

A first direction DIR1 is defined by a relative displacement between the first display area 21 and the second display area 22 and a second direction DIR2 is defined as orthogonal to the first direction DIR1 and in a plane occupied by the first and second display areas. A displacement or velocity of the user interface element may therefore be expressed as a two component vector (A, B) where A is the component in the first direction DIR1 and B is the component in the second direction DIR2.

In the first display area 21, the user interface element 10 is moved by a user between a first position (A1, B1) and a second position (A2, B2) over a time t1. The velocity of the user interface element 10 may be determined as ((A2−A1)/t1, (B2−B1)/t1).

The travel time t2 to traverse the separation distance S in the second direction DIR2 between the first display area 21 and the second display area 22 is determined as:

t2=S*t1/(A2−A1)

The travel time t2 across the interface is dependent upon the size of a separation S, provided by the interface 16, between the first display area 21 and the second display area 22 and is dependent upon a velocity of the displayed user interface element 10 in the first display area 21. As the trajectory and/or the magnitude of the velocity changes the travel time t2 changes.

In some embodiments the travel time t2 may additionally or alternatively be dependent upon a characteristic of the user interface element 10.

It is also possible to have embodiments in which the travel time t2 is set to zero.

If the velocity of the user interface element 10 has a non zero component in the second direction DIR 2, then when the displayed user interface element 10 is moved from the first display area 21 to the second display area 22 across the interface there may be a relative displacement of the user interface element 10 not only in the first direction DIR1 but also in the second direction DIR2.

The relative displacement H of the user interface element 10 in the second direction DIR2 caused by traversing the interface 16 may be determined as:

H=S*(B2−B1)/(A2−A1)

The relative displacement H in the second direction DIR2 is dependent upon a size of a separation S, provided by the interface, between the first display area 21 and the second display area 22 and dependent upon a trajectory of the velocity of the displayed user interface element 10 in the first display area 21.

The relative displacement H may also be dependent upon a characteristic of the user interface element 10.

In some embodiments the display controller 6 is configured to move a portion of the displayed user interface element 10 from an edge 23 of the first display area 21 to an edge 24 of the second display area 22 automatically when the criteria is satisfied, in other embodiment the display controller 6 is configured to move the portion of the displayed user interface element 10 from the edge 23 of the first display area 21 to a distance beyond the edge 24 of the second display area 22 automatically when the criteria is satisfied.

The user interface element 10 when it is moved automatically to a distance L beyond the edge 24 of the second display area 22 may follow a trajectory of the previous velocity of the user interface element 10 at the first display area 21. The trajectory may, for example, be defined as a ratio of the velocity component in the second direction DIR2 to the velocity component in the first direction DIR1 e.g. (B2−B1)/(A2−A1) or alternatively by an elevation angle θ that measures the elevation of the trajectory of the velocity relative to the first direction DIR1. These are related by tan θ=(B2−B1)/(A2−A1).

The speed of the user interface element 10 in the second display area when it is moved automatically to a distance beyond the edge 24 of the second display area 22 may decrease as the distance from the edge 24 increases. It may also be dependent upon the size of the user interface element decreasing more quickly for larger user interface elements 10.

Movement of the user interface element from a first display area to a second display area across the interface 16 in an attract/repel mode will be described with reference to FIG. 4.

In this mode, the user interface element is initially in the first display area 21, when the criteria is satisfied (block 42). The user interface element 10 is moved automatically by the controller 6 towards the interface (block 43). The user interface element 10 is then moved automatically by the controller 6 from the first display area 21 to the second display area 22 across the interface 16. The user interface element 10 is then moved automatically by the controller 6 away from the interface in the second display area 22.

The criteria may be satisfied when the user interface element 10 is moved to be positioned proximal to the interface 16.

The displayed user interface element 10 may be moved towards the interface 16 in the first display area 21 with a speed or momentum which is dependent upon a distance between the user interface element 10 and the interface and which increases as the distance between the user interface element 10 and the interface decreases. Typically the speed/momentum only has a component in the first direction DIR1.

The displayed user interface element 10 may be moved away from the interface 16 in the second display area 22 with a speed or momentum which is dependent upon distance between the user interface element 10 and the interface 16 and which decreases as the distance between the user interface element 10 and the interface increases. Typically the speed/momentum only has a component in the first direction DIR1.

Movement of the user interface element from a first display area to a second display area across the interface 16 in a follower mode will be described with reference to FIG. 4.

In this mode, the user interface element 10 is initially in the first display area 21. The displayed user interface element 10 is moved towards the interface 16 under user control (block 41) to satisfy the criteria (block 42). The user interface element 10 is then moved automatically by the controller 6 from the first display area 21 to the second display area 22 across the interface 16 (block 45). Then the displayed user interface element 10 is moved away from the interface 16 into the second display area 22 under user control (block 45).

The criteria may be satisfied when the user interface element 10 is moving towards the interface 16 and is proximal to the interface 16. The user interface element 10 follows the prior trajectory of the user input point 11 as it moves from one display area 21 to the other display area 22. For example, if the user input element 10 is moved by tracing a finger over the first display area 21, then the user's finger can be moved across the first display area, over the interface 16 and into the second display area 22 to pick-up the user interface element and move it again by tracing the finger. Therefore although the interface is not touch sensitive, the display controller 6, by predicting the movement of the user's finger and displaying the user interface element at the edge 24 of the second display area 22 where it predicts the user's finger to be, it can give the impression that the interface 16 is touch sensitive.

The velocity of the user interface element 10 as it is moved towards the interface 16 determines where (relative displacement H) and when (travel time t2) the user interface element 10 enters the second display area 22.

Movement of the user interface element from a first display area to a second display area across the interface 16 in a throw mode will be described with reference to FIG. 4.

In this mode, the user interface element is initially in the first display area 21. The displayed user interface element 10 is moved towards the interface 16 in response to user input (block 41) to satisfy the criteria (block 42). The user interface element 10 is then moved automatically by the controller 6 from the first display area 21 to the second display area 22 across the interface 16 (block 45). Then the displayed user interface element 10 is moved automatically away from the interface 16 into the second display area 22 (block 45).

The criteria may be satisfied when the user interface element 10 is moving towards the interface 16 but is not necessarily proximal to the interface 16. This may occur for example when a user ‘throws’ the user interface element 10 at the interface by selecting the user interface element 10, accelerating the user interface element 10 towards the interface 16 and de-selecting (releasing) the user interface element 10 before it reaches the interface 16.

The trajectory of the user interface element 10 as it is moved towards the interface 16 may determine where (relative displacement H) the user interface element 10 enters the second display area 22.

The magnitude of the acceleration of the user interface element 10 may determine when (travel time t2) the user interface element 10 enters the second display area 22.

The displayed user interface element 10 may be moved automatically away from the interface 16 in the second display area 22 with a speed or momentum which is dependent upon distance between the user interface element 10 and the interface and which decreases as the distance between the user interface element 10 and the interface increases. Typically the speed/momentum only has components that match the trajectory of the user interface element 10 as it was accelerated towards the interface 16.

Referring back to FIG. 1, the controller 6 may be implemented using instructions that enable hardware functionality, for example, by using executable computer program instructions in a general-purpose or special-purpose processor that may be stored on a computer readable storage medium (disk, memory etc) to be executed by such a processor.

In an embodiment where the controller 6 is provided using a processor, the processor 6 is configured to read from and write to the memory 8. The processor 6 may also comprise an output interface via which data and/or commands are output by the processor 6 and an input interface via which data and/or commands are input to the processor 6.

The memory 8 stores a computer program 60 comprising computer program instructions that control the operation of the apparatus 2 when loaded into the processor 6. The computer program instructions 60 provide the logic and routines that enables the apparatus to perform the methods illustrated in FIGS. 2A-2E, 4, 5 and 6. The processor 6 by reading the memory 8 is able to load and execute the computer program 60.

The apparatus therefore comprises: at least one processor 6; and

at least one memory 8 including computer program code 60
the at least one memory 8 and the computer program code 60 configured to, with the at least one processor, cause the apparatus at least to perform:
moving a displayed user interface element 10 to track in real-time a user input point 11 controlled by a user in a first display area 21;
moving the displayed user interface element 10 from the first display area 21 to a second display area 22 automatically when a criteria is satisfied.

The computer program may arrive at the apparatus 2 via any suitable delivery mechanism. The delivery mechanism may be, for example, a non-transitory computer-readable storage medium, a computer program product, a memory device, a record medium such as a compact disc read-only memory (CD-ROM) or digital versatile disc (DVD), an article of manufacture that tangibly embodies the computer program 60. The delivery mechanism may be a signal configured to reliably transfer the computer program 60. The apparatus 2 may propagate or transmit the computer program 60 as a computer data signal.

Although the memory 8 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.”

As used here ‘module’ refers to a unit or apparatus that excludes certain parts/components that would be added by an end manufacturer or a user. The controller 6 may be a module.

The blocks illustrated in the FIG. 4 may represent steps in a method and/or sections of code in the computer program 60. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

For example, although the above described examples have used only two distinct display areas, the pair of display areas may be considered as any permutation or combination of two adjacent display areas in a multi-display area system.

Although the interface 16 is illustrated as a narrow gap in some embodiments it may be large, for example larger than a dimension or maximum dimension of a display area. The display areas do not need to be attached to each other. If the pair of display areas are not attached to each other, a mechanism may be provided for measuring the distance between display areas. For example, transmitters and receivers may be used to measure the distance using time of flight estimation.

For example, the apparatus 2 comprises: means for moving a displayed user interface element 10 to track in real-time a user input point controlled by a user in a first display area 21; and means for moving the displayed user interface element 10 from the first display area 21 to a second display area 22 automatically when a criteria is satisfied.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
a first display area;
a second display area; and
an interface separating the first display area from the second display area; and
a display controller configured to move a displayed user interface element to track in real-time a user input point controlled by a user in a first display area and to move the displayed user interface element from the first display area to a second display area automatically when a criteria is satisfied.

2. An apparatus as claimed in claim 2, wherein the criteria is dependent upon a distance of the user interface element from the interface.

3.-4. (canceled)

5. An apparatus as claimed in claim 1, wherein the criteria is dependent upon a characteristic of the user interface element.

6. (canceled)

7. An apparatus as claimed in claim 1, wherein there is an apparent travel time across the interface when automatically moving the displayed user interface element from the first display area to the second display area across the interface and wherein the travel time is dependent upon a size of a separation between the first display area and the second display area provided by the interface, and/or a velocity of the displayed user interface element in the first display area and/or a characteristic of the user interface element.

8.-11. (canceled)

12. An apparatus as claimed in claim 1, wherein a first direction is defined by a relative displacement between the first display area and the second display area and a second direction is defined as orthogonal to the first direction and in a plane occupied by the first and second display areas, wherein when automatically moving the displayed user interface element from the first display area to the second display area across the interface there is a relative displacement of the user interface element not only in the first direction but also in the second direction.

13. An apparatus as claimed in claim 12, wherein the displacement in the second direction is dependent upon one or more of: a size of a separation, provided by the interface, between the first display area and the second display area, a velocity of the displayed user interface element in the first display area, a characteristic of the user interface element.

14.-24. (canceled)

25. An apparatus as claimed in claim 1, wherein the display controller is configured, when the criteria is satisfied, to automatically move the displayed user interface element: towards the interface in the first display area; from the first display area to the second display area; and away from the interface in the second display area.

26. An apparatus as claimed in claim 25, wherein the display controller is configured, when the criteria is satisfied, to automatically move the displayed user interface element towards the interface in the first display area with a speed that increases as a separation distance between the user interface element and the interface decreases.

27. (canceled)

28. An apparatus as claimed in claim 25, the display controller is configured, when the criteria is satisfied, to automatically move the displayed user interface element from the interface in the second display area with a speed that decreases as a separation distance between the user interface element and the interface increases.

29.-31. (canceled)

32. An apparatus as claimed in claim 1, wherein the display controller is configured to move the displayed user interface element towards the interface in the first display area under user control; to automatically move the user interface element from the first display area to the second display area when the criteria is satisfied; and to move the displayed user interface element away from the interface in the second display area under user control.

33. An apparatus as claimed in claim 32, wherein a first direction is defined by a relative displacement of the first display area and the second display area and a second direction is defined as orthogonal to the first direction and in a plane occupied by the first and second display areas, wherein when automatically moving the displayed user interface element from the first display area to the second display area across the interface there is a relative displacement of the user interface element in the first direction and the second direction, wherein the relative displacement of the user interface element in the second direction is dependent upon a velocity of the user interface element in the first display area.

34.-35. (canceled)

36. An apparatus as claimed in claim 1, wherein the display controller is configured to move the displayed user interface element towards the interface in the first display area in response to user input; to automatically move the user interface element from the first display area to the second display area when the criteria is satisfied; and to automatically move the displayed user interface element: away from the interface in the second display area.

37. (canceled)

38. An apparatus as claimed in claim 36, wherein the display controller is configured to automatically move the displayed user interface element from the interface in the second display area with a speed that decreases as a separation between the user interface element and the interface increases.

39. (canceled)

40. An apparatus as claimed in claim 1, wherein the first display area is configured to provide touch sensitive user input and the second display area is configured to provide touch sensitive user input.

41. A method comprising:
moving a displayed user interface element to track in real-time a user input point controlled by a user in a first display area; and
moving the displayed user interface element from the first display area to a second display area automatically when a criteria is satisfied.

42.-43. (canceled)

44. A method as claimed in claim 41, wherein a first direction is defined by a relative displacement of the first display area and the second display area and a second direction is defined as orthogonal to the first direction and in a plane occupied by the first and second display areas, wherein when automatically moving the displayed user interface element from the first display area to the second display area across the interface there is a relative displacement of the user interface element not only in the first direction but also in the second direction.

45. A method as claimed in claim 44, wherein the displacement in the second direction is dependent upon: a size of a separation, provided by the interface, between the first display area and the second display area; and/or a velocity of the displayed user interface element in the first display area; and/or a characteristic of the user interface element.

46. A method as claimed in claim 41, comprising, when the criteria is satisfied, automatically moving the displayed user interface element: towards the interface in the first display area; from the first display area to the second display area; and away from the interface in the second display area.

47. A method as claimed in claim 41, comprising:
moving the displayed user interface element towards the interface in the first display area under user control;
automatically moving the user interface element from the first display area to the second display area when the criteria is satisfied; and
moving the displayed user interface element away from the interface in the second display area under user control.

48.-50. (canceled)

51. An apparatus comprising:
at least one processor; and
at least one memory including computer program code
the at least one memory and the computer program code configured to, with the at least one processor, cause the apparatus at least to perform:
moving a displayed user interface element to track in real-time a user input point controlled by a user in a first display area;
moving the displayed user interface element from the first display area to a second display area automatically when a criteria is satisfied.

52. (canceled)
